(19) United States
(12) Patent Application Publication
(10) Pub. No.: US 2026/0004158 A1
(43) Pub. Date: Jan. 1, 2026

(54) UNIFIED IN-CONTEXT PROMPT OPTIMIZATION FOR LARGE LANGUAGE MODELS

(71) Applicant: Intuit Inc., Mountain View, CA (US)

(72) Inventors: Wendi CUI, Jersey City, NJ (US); Jiaxin ZHANG, Mountain View, CA (US); Damien LOPEZ, San Diego, CA (US); Kamalika DAS, Saratoga, CA (US); Sricharan Kallur Palli KUMAR, Milpitas, CA (US)

(21) Appl. No.: 18/758,667

(22) Filed: Jun. 28, 2024

(51) Int. Cl. G06N 5/022

(52) U.S. Cl. CPC G06N 5/022

(57) ABSTRACT

Certain aspects of the disclosure provide unified in-context prompt optimization for large language models that achieves joint optimization of prompt instruction and examples. A multi-phase approach is provided that includes multiple mutation operations. Further, the approach alternates between optimization strategies for exploration for global search and exploitation for local search. Global initialization creates a diverse set of candidate prompts based on the availability of data and utilizing Lamarckian or semantic mutation. Local feedback mutation, global evolution mutation, and local semantic mutation can subsequently be employed iteratively to generate a revised set of candidate prompts. A prompt from the revised set of candidate prompts can be selected based on an evaluation of the candidate prompts. Subsequently, the selected prompt can be output for a machine-learning task.

### BACKGROUND

### Field

Aspects of the subject disclosure relate to automated prompt optimization for large language models.

### Description of Related Art

Large language models (LLMs) have exhibited extraordinary performance across various domains and tasks. Prompt engineering involves crafting effective prompts that improve an LLM's performance for specific tasks. For example, prompt engineering may include designing instructions and examples to provide to the LLM to guide the LLM in generating an output. However, prompt engineering is a manual process that requires considerable time and effort to generate a prompt. Further, tuning a prompt to achieve improved performance requires significant human resources and expert knowledge.

### SUMMARY

Certain aspects provide a method comprising generating an initial set of candidate prompts for a machine learning task, executing multi-phase mutation starting with the initial set of candidate prompts to produce a revised set of candidate prompts including at least one candidate prompt that comprises an instruction and one or more examples, wherein the multi-phase mutation transitions sequentially through phases with different mutation operations, generating a fitness score for each candidate prompt in the revised set of candidate prompts resulting from the multi-phase mutation, selecting a prompt from the revised set of candidate prompts based on the fitness score for each candidate prompt, and outputting a selected prompt for the machine-learning task.

Certain aspects also provide a method of prompt generation, comprising generating an initial set of candidate prompts based on input and output pairs or a human-generated prompt, executing a multi-phase mutation on the initial set of candidate prompts to produce a revised set of candidate prompts. Executing the multi-phase mutation comprises executing a local feedback mutation on the initial set of candidate prompts to produce a first intermediate revised set of candidate prompts, executing a global evolution mutation on the first intermediate revised set of candidate prompts to produce a second intermediate revised set of candidate prompts, and executing a local semantic mutation on the second intermediate revised set of candidate prompts to produce the revised set of candidate prompts. Further, the method comprises generating a fitness score for each candidate prompt in the revised set of candidate prompts resulting from the multi-phase mutation, selecting a prompt from the revised set of candidate prompts based on the fitness score for each candidate prompt, and outputting a selected prompt for a machine-learning task.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example implementation of prompt optimization for a large language model.

FIG. 2 depicts gradient diagrams illustrating multiple prompt optimization phases.

FIG. 3 is a flow chart diagram of an example method of prompt optimization.

FIG. 4 is a flow chart diagram of an example method of multi-phase prompt optimization.

FIG. 5 depicts an example processing system with which aspects of the present disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for unified in-context prompt optimization for large language models.

Prompting is a technique employed in natural language processing and machine learning to guide the behavior and output of language models. Prompting involves providing specific instructions and, optionally, examples to a language model to elicit desired outputs. Researchers and developers can carefully craft prompts that shape the behavior of language models and direct them toward specific tasks or objectives. Well-designed prompts can help the model comprehend the context, infer the desired output, and generate responses that align with an intended task or purpose. Prompting is particularly useful in tasks like text generation, question answering, sentiment analysis, and language translation. A deep understanding of the task, the model's capabilities, and the desired output is often required to construct effective prompts. Further, effective prompting often involves iterative refinement and experimentation to find the optimal prompt that yields the desired output.

Conventional techniques rely on manual crafting of prompts, which is time-consuming and often results in suboptimal performance. Further, it is technically challenging to consistently select examples that provide the necessary context for accurate outputs. Conventional techniques fail to achieve optimal performance by considering prompt instruction and prompt examples as separate problems. Computational efficiency is also a problem, as prompt optimization often requires significant computational resources and time.

Aspects described herein provide a technical solution for optimizing prompt generation for large language models. In particular, described herein are systems and methods of automated prompt generation that consider and are capable of producing instructions and examples that improve prompt performance through joint optimization. In some aspects, the generative capability of an LLM combined with the global search proficiency of evolutionary algorithms is employed to enhance search efficiency and accelerate convergence on optimal prompts. Further, in some aspects, prompt generation alternates between global search and local optimization to balance exploration and exploitation, expedite convergence, and improve efficiency. Various mutation operators with unique strengths may be utilized to maximize prompt performance, and adaptive termination may be incorporated based on performance gain and mutation operator-specific tolerance to optimize the prompt computationally efficiently.

### Example Implementation of Prompt Optimization

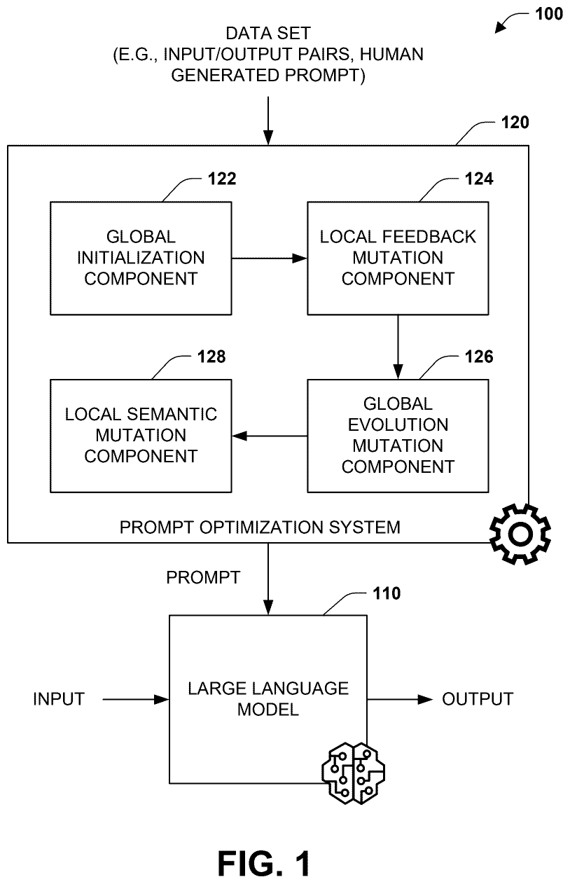

FIG. 1 depicts an example implementation of prompt optimization, including a large language model 110 and a prompt optimization system 120.

The large language model (LLM) 110 is a machine learning model capable of understanding and generating natural language. An LLM is trained on immense amounts of data to enable the LLM to perform various tasks, such as text generation, translation, and content summarization. The LLM 110 can receive input from a user, which is information or text provided by the user to interact with the LLM 110. The input can be a query, a question, or any other text a user wants the LLM 110 to process and generate a response. The LLM 110 generates an output (e.g., a response) based on the input. For example, the output can be an answer to an input question. The LLM 110 can also receive a prompt as additional input. The prompt can be text to guide the LLM 110 in generating a desired output. The prompt can include an instruction, a set of examples that demonstrate desired behavior, or both. The user input can be combined with the prompt to form the complete input for the LLM 110.

Prompts are manually specified conventionally, which leads to problems that can affect the performance and output of the LLM. For example, manually crafting prompts has the potential for bias and subjectivity. Further, manual prompts may not cover all variations and edge cases, leading to suboptimal and inaccurate output in conjunction with complex queries. Automated or data-driven approaches to prompt generation can aid in addressing these issues to improve the performance of the LLM 110. However, automated approaches also suffer from various problems, including a lack of consideration of both instruction and examples. Such approaches also have the potential to generate lengthy, inefficient prompts, which may also negatively affect the performance of the model being prompted.

The prompt optimization system 120 is operable to generate unified in-context prompts automatically. Unified in-context refers to jointly optimizing a prompt (e.g., instruction) and the context (e.g., examples) in which it is used. This involves finding an optimal prompt that effectively leverages the given context to improve the performance of language models. An iterative optimization process can be employed to treat the prompt and context as a unified whole.

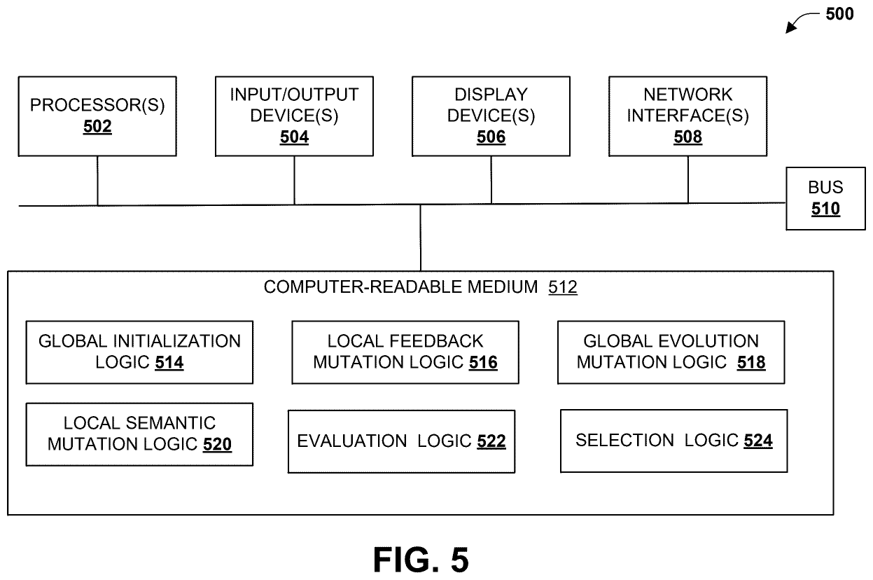

More specifically, the prompt optimization system 120 generates instructions and zero or more examples to improve responses from the large language model 110. The prompt optimization system includes a global initialization component 122, local feedback mutation component 124, global evolution mutation component 126, and local semantic mutation component 128. Each component can be implemented by at least one processor (e.g., processor 502 of FIG. 5) coupled to at least one memory (e.g., memory 512 of FIG. 5) that stores instructions that cause the at least one processor to perform the functionality of each component when executed. Consequently, a computing device can be configured to be a special-purpose device or appliance that implements the functionality of the prompt optimization system 120. Further, all or portions of the prompt optimization system 120 can be distributed across computing devices or accessible through a network service.

The global initialization component 122 is operable to implement global initialization of prompt optimization by generating an initial diverse population or set of candidate prompts to explore the joint space of instruction and examples. The global initialization component 122 can receive inputs such as input/output data sets or prompt examples provided by human experts. The output is a set of diverse initial prompts that serve as a starting point or seed for optimization.

Given a set of input and output pairs, the global initialization component 122 can reverse engineer the prompt from the demonstrating pairs using, for example, Lamarckian mutation, a reverse engineering operator, to determine the prompt from the provided input and output pairs. In one embodiment, an LLM can be employed to implement Lamarckian mutation. For example, an LLM prompt can be “I gave a friend an instruction and some inputs. The friend read the instruction and wrote an output for every one of the inputs. Here are the input-output pairs: ##Example ##{input output pairs}. What was the instruction?”

If a human expert prompt example is provided, this enables a jump-start to the evolution process by incorporating prior knowledge. The global initiation component 122 can also execute a semantic operator on the expert prompt example to enhance the diversity of the initial population by providing additional prompts with similar meaning as the expert prompt. In one embodiment, an LLM can be employed to implement semantic mutation. For example, an LLM can be employed with the following input: “You are a mutator. Given a prompt, your task is to generate another prompt with the same semantic meaning and intentions. ##Existing Prompt ##[existing prompt} What is the newly mutated prompt?”

The global initialization component 122 provides numerous technical benefits or advantages. For instance, global initialization ensures that optimization starts with a diverse set of prompts. Starting with a diverse set of prompts avoids getting trapped in a local optima (e.g., a prompt that performs well but is not the best possible prompt). Furthermore, a good starting point is provided for subsequent optimization through feedback mutation, evolutionary mutation, and semantic mutation to efficiently search for better solutions. Global initialization can also exploit expert knowledge for prompt generation. By utilizing expert prompt examples, the global initiation component 122 can leverage their expertise and insights, leading to more effective high-quality prompts.

The local feedback mutation component 124 is operable to generate new prompt candidates based on existing prompts. The global initialization component 122 can provide an initial set of candidate prompts as a starting point for generating new prompt candidates and a revised set of candidate prompts. However, the initial set of candidate prompts can be diverse and each prompt may be distant from its local optimal solution. To address this issue, the local feedback mutation component 124 can expedite convergence of each candidate prompt to its local minimum utilizing gradient information. In accordance with one embodiment, an LLM can be utilized to implement local feedback mutation. For example, an LLM can be prompted to act as an examiner to scrutinize where a current candidate prompt falls short and to offer improvement guidance, such as “gradient information.” For example, a candidate prompt can fall short when it produces the wrong results. The gradient information can refer to the guidance provided as it indicates the direction in which the prompt should be modified to enhance performance. The gradient information is next employed by an LLM improver, which leverages an LLM to generate new candidates by local exploitation. The LLM improver can comprise an LLM prompted to act as a prompt improver. For example, the following input can be provided to an LLM: “You are a quick improver. Given an existing prompt and feedback on how it should be improved, create an improved version based on the feedback. “##Existing Prompt ## {existing prompt} ##Feedback ##{feedback}.”

The local feedback mutation component 124 is utilized to introduce variations or modifications into candidate prompts based on feedback to improve prompts, which leads to better performance by the LLM. Further, the local feedback mutation component 124 provides automated prompt enhancement, local search space exploration, and fast convergence on a local optimal prompt. Local search space exploration can refer to exploring and evaluating different variations of a prompt in close proximity to a current prompt, which can involve making small localized modifications to the prompt with the goal of locating a prompt that performs well within a specific region or locality of search space. Fast convergence can refer to rapidly converging on a local optimal prompt within an explored region. Converging on a local optimal prompt may lead to improved performance in a specific region but may not necessarily result in the best overall performance. However, employing a global, local, global, and local prompt refinement strategy seeks to strike a balance between exploration and exploitation to determine the best possible prompt.

The global evolution mutation component 126 is operable to select parent prompts from a current population of candidate prompts and generate new candidate prompts using evolution operators or techniques. More specifically, the global evolution mutation component 126 seeks to escape local optima by exploring prompts at a global rather than local scale. The global evolution mutation component receives a current population of prompts that may have been refined through previous phases and corresponding components, namely the global initiation component 122 and local feedback mutation component 124. A set of parent prompts is selected from the current population of prompts, which serves as the basis for generating new prompts. Two evolutionary operators that can be utilized by the global evolution mutation component 126 include estimation of distribution (ED) and crossover (CR).

The ED operator selects parent prompts from the set of parent prompts based on a distance metric, such as Hamming distance or Cosine distance, which measures the similarity between prompts. The ED operator aims to promote diversity and selects parent prompts that exhibit distinct attributes as determined based on the distance metric (e.g., farther apart). Although any similarity or distance measurement can be employed, Hamming distance focuses on the number of differing elements between strings. Accordingly, Hamming distance is particularly useful when dealing with text-based or string prompts and ensuring that one candidate prompt is more likely to be paired with a candidate prompt that does not include the same mistakes, thereby producing a diverse population. Further, employment of Hamming distance can work hand-in-hand with a performance-based vector, namely composing a vector of correct and incorrect answers to test cases. For example, if a candidate answers five questions and the first three are correct and the last two are incorrect, the vector can be ‘[1, 1, 1, 0, 0].”

In accordance with one embodiment, a fitness function can score each candidate in a set or population of candidates. The score can reflect the quality or performance with respect to a specific task or test data set. The ED operator can generate a probability distribution (e.g., Gaussian distribution) based on the fitness scores, and the probability distribution can then guide the selection of parent pairs. Selection of the pairs can be performed in different ways. For example, prompts can be selected by sampling prompts based on their probabilities in the distribution. In another instance, prompts can be selected based on fitness scores as well as their probabilities in the distribution. Overall, the probability distribution helps identify parent pairs by providing a quantitative measure of the fitness or quality of each prompt. By employing probabilities in the distribution, the selection process can be biased toward prompts that have high fitness scores, increasing the likelihood of selection of good parents. A mutation operation can be performed on selected parents to generate new candidate prompts that introduce random changes and create diversity in the set of candidate prompts.

Similar to ED, the CR operator can select and combine the parent prompts to generate a new prompt. Parent prompts can be selected based on their fitness or objective function values. For example, the two prompts with the highest fitness scores can be selected. Alternatively, parent prompts can be selected based on their diversity or distinctiveness. A crossover point can be chosen within parent prompts, which determines where genetic material will be exchanged. Genetic material beyond the crossover point in one parent can be swapped with corresponding genetic material from the other parent prompt and combined through concatenation, merging, or other blending to create a new prompt. Combining material from two parent prompts generates a new prompt that inherits both parents' characteristics. Among other things, this allows the exploration of different combinations of prompt elements and further provides diversity in the prompt population. In accordance with one embodiment, the instruction of a first-parent prompt can be combined with one or more examples of a second-parent prompt or vice versa to produce a child prompt.

As another more specific example, consider parent prompt 1: “Now you are a categorizer, and your mission is to ascertain the sentiment of the provided text, either favorable or unfavorable,” and parent prompt 2: “Assign a sentiment label to the given sentence from [‘negative’, ‘positive’] and return only the label without any other text.” The offspring prompt can be “Your mission is to ascertain the sentiment of the provided text and assign a sentiment label from [‘negative’, ‘positive].”

The local semantic mutation component 128 is operable to implement small, localized changes to a prompt while preserving the prompt's overall semantic meaning. The current prompt population, updated by the global evolution mutation component 126, is received as input. The output is a prompt population with at least one mutated prompt incorporating semantic variations. The local semantic mutation component 128 can analyze a prompt, identify specific portions that can be modified, and apply semantic transformations to introduce variations while maintaining the intended meaning. Semantic transformations can be performed by applying linguistic operations or modifications to specific segments or tokens of a prompt. Various techniques can be utilized to perform semantic transformations, including synonym replacement, paraphrasing, and contextual adaptation, among others.

Further, an LLM, including the LLM 110, can be employed to perform semantic mutation. For example, an LLM can generate alternative wordings, paraphrases, synonyms, and contextually appropriate substitutions to introduce prompt variations through semantic mutations. One example implementation can be “You are a mutator. Given a prompt, your task is to generate another prompt with the same semantic meaning and intensions #Example Current prompt: Your mission is to ascertain the sentiment of the provided text and assign a sentiment label from [‘negative’, ‘positive’]. Mutated prompt: Determine the sentiment of the given sentence and assign a label from [‘negative’, ‘positive’]. Given{pass_in_data].”

In accordance with one embodiment, each component in the prompt optimization system 120 can be associated with a minimum runtime in terms of time, cycles, or iterations that may vary from component to component. The minimum runtime can represent the minimum processing by a component before transitioning to the next phase or component. Minimum runtimes ensure that each phase is given enough time to explore a prompt space effectively. Further, minimum runtimes can prevent premature phase termination, which refers to termination based on early results or limited exploration that potentially misses better solutions, and allow prompt optimization before moving on to a subsequent phase and component.

Further, the output of each component in the prompt optimization system 120 can be evaluated before proceeding to the next component. Prompt performance can be evaluated with a scoring function with respect to a testing data set and performance criteria that include metrics such as accuracy, precision, recall, or other task-specific metrics. For example, in a classification task, accuracy can correspond to a generated classification that is correct or meets the ground truth, which can be used to gauge performance of a prompt. The performance criteria can serve as a benchmark to ensure the quality of prompts and guide decision-making. For example, prompt performance can also be considered when deciding when to advance to the next component and stage. If the prompts produced by a component meet or exceed the performance criteria, processing can move to the next stage. Otherwise, further iterations or modifications may be required in the current stage.

In one particular embodiment, performance improvement can be considered. Performance improvement can be measured by determining the difference between a current performance score and a prior performance score determined by a scoring function. If an improvement threshold is met, processing can transition to the next component or phase. Otherwise, further processing can continue to be performed by the current component or in the current stage. For example, new prompts can be evaluated after a mutation iteration. In one instance, a transition is triggered if an improvement threshold is reached prior to satisfying a minimum runtime. As a result, optimization can continue until a significant improvement in prompt performance is achieved. Alternatively, if a minimum runtime is reached before an improvement threshold is met, transitioning may still occur to prevent a process from remaining in a single phase for an extended period. In other words, processing can continue by a component until either a minimum runtime or improvement threshold is reached, resulting in a balance between optimization time and prompt performance.

In one embodiment, the local semantic mutation component 128 can return a revised set of candidate prompts. In this instance, the prompt optimization system 120 can provide further processing to determine and return a single prompt by evaluating each candidate prompt based on its performance on a testing data set using a score function. The candidate prompt with the highest performance score can be selected as the optimal in-context prompt. In accordance with one embodiment, the score function can be a fitness score that measures how well a prompt performs on a given task or benchmark, and the score is calculated based on an evaluation data set and a specific evaluation metric.

As an example scenario, suppose a human specified the following prompt, “Is the following prejudicial speech? Output format: True or False.” The prompt optimization system 120 can receive this prompt and generate an optimized prompt. In one instance, the prompt optimization system 120 could respond with an improved instruction only, such as “Does the provided text contain prejudicial speech? Return a Boolean value of True or False.” However, the prompt optimization system 120 can consider not only instructions but also examples to produce an optimal in-context prompt. Accordingly, the prompt optimization system 120 could return, “Your task is to evaluate whether the provided input includes any offensive language. . . . For instance, the phrase ‘You are a fool’ is offensive due to its derogatory tone, so you should return ‘True.’ The phrase ‘This is a damn tasty pizza’ includes profanity, but it is not offensive, so you should return ‘False’.”

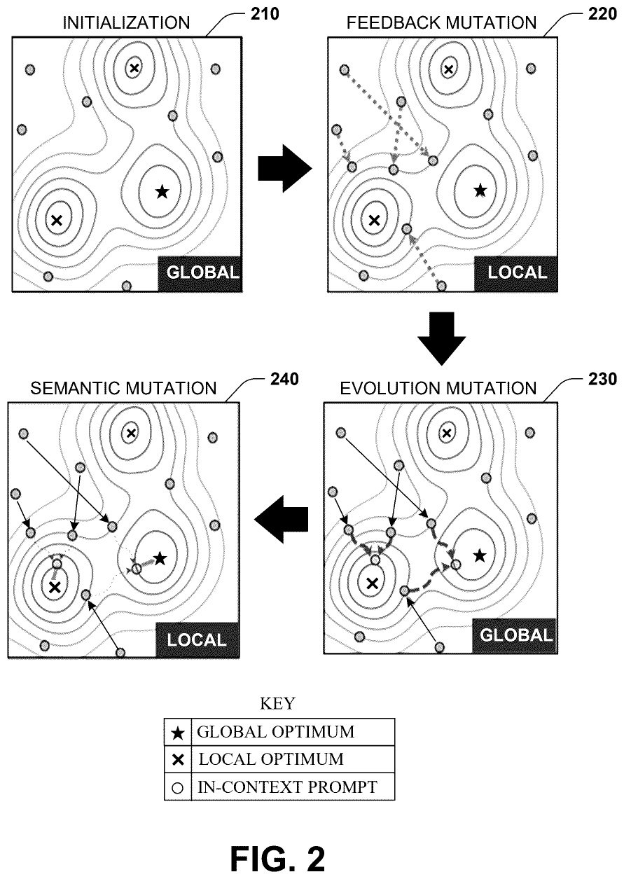

FIG. 2 depicts gradient diagrams illustrating multiple prompt optimization phases. FIG. 2 provides a visual representation of the optimization process and flow of information. Gradient diagrams are shown for four phases, namely initialization 210, feedback mutation 220, evolution mutation 230, and semantic mutation 240. Each phase represents a specific stage in a prompt optimization process. Further, the phases result, respectively, from the functionality provided by the global initiation component 122, local feedback mutation component 124, global evolution mutation component 126, and local semantic mutation component 128 of FIG. 1. Further, the gradient diagrams follow an approach that performs global exploration, local exploitation, global exploration, and local exploitation to determine a globally optimal solution efficiently.

Initialization 210 depicts a gradient that includes local and global optima. The global optimum is represented as a star, and the local optima are represented by the letter “X.” Circles represent in-context prompts, including an instruction and zero or more examples. Eight in-context prompts are shown. The in-context prompts are diversely distributed across the search space, depicted by the gradient lines and various optima. Diverse initial prompts allow for a broader exploration of a solution search space. The diverse distribution can result from exploiting human knowledge and automatically generating prompts from input/output pairs. By starting with a diverse set of prompts, different regions of the search space can be explored to discover a wide range of potential solutions. Further, local optima are suboptimal solutions located in particular regions of a search space. If the initial prompts are clustered around a particular area, an optimization process may be trapped in a local optimum and fail to discover better solutions in other regions. Diverse initial prompts mitigate this problem by providing more comprehensive search space coverage to allow escape from a local optimum. Furthermore, diverse initial prompts promote solution diversity throughout the prompt optimization process, which may lead to solutions that may not have been possible with a less diverse set of initial prompts.

Feedback mutation 220 depicts a feedback gradient mutation for local search of the solution space to expedite convergence and improve efficiency. Feedback mutation involves generating new in-context prompts moving in the opposite semantic direction of the gradient. The feedback mutation 220 illustrates generation of new prompts based on a subset of previous prompts and a gradient. The new prompts are closer to local and global optima than the initial prompt and reside at the arrowhead side of the line.

Evolution mutation 230 illustrates the application of global evolution mutation to the prompts to a set of candidate prompts refined by feedback mutation. The candidates returned by feedback mutation can converge on local optima instead of a global optimum. Accordingly, a global search is performed. Global evolution mutation seeks to explore different prompt variations. More specifically, pairs of prompts can be used as parents to generate new prompts through an evolutionary mutation process. For example, estimation of distribution mutation (ED) and crossover (CR) can be utilized to produce new prompts. As illustrated, candidate pairs are combined to produce new candidates closer to optima.

Semantic mutation 240 illustrates the application of a local semantic mutation to expedite convergence of the optimization process and improve the efficiency of locating the global optimal solution. In semantic mutation, prompts are modified through paraphrasing to generate a new prompt that shares the same semantic meaning and focuses on fine-tuning prompts based on semantic properties. Semantic mutation is applied to the set of candidate prompts produced by evolution mutation. As shown, semantic mutation 240 generates prompt candidates corresponding to local and global optimal solutions. The global optimal prompt can be returned as the output of a prompt optimization process.

### Example Methods of Prompt Optimization

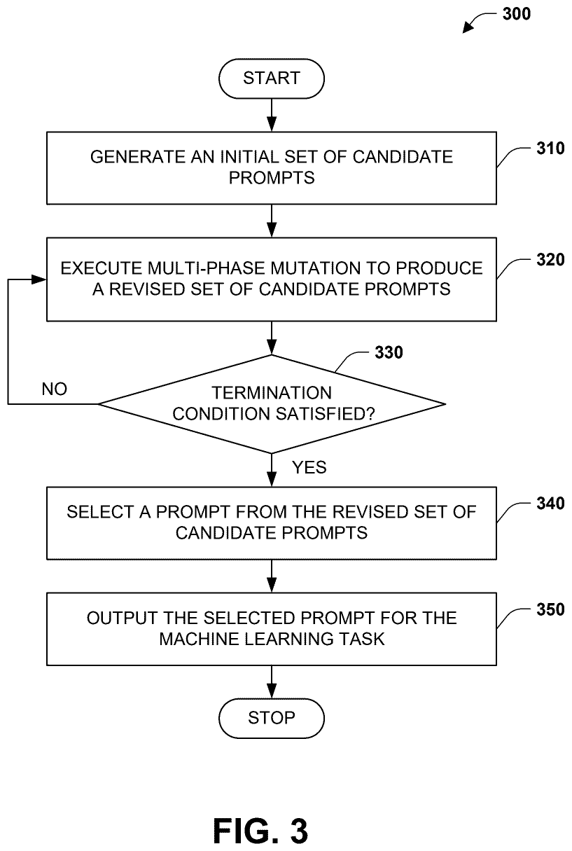

FIG. 3 depicts an example method 300 of prompt optimization for a large language model. In one aspect, method 300 can be implemented by the prompt optimization system 120 of FIG. 1 and the processing apparatus of FIG. 5.

The method 300 starts at block 310 with generating an initial set of candidate prompts. There are at least two ways to create an initial population or set of candidate prompts based on the availability of data and human expert knowledge. If data is available, for example, in the form of input and output pairs, the prompts that produced the outputs from the inputs can be reverse engineered utilizing Lamarckian mutation and utilized as the initial set of candidate prompts. If a human expert provides a prompt, semantic mutation can be employed to generate the initial set of candidate prompts by modifying the prompt to enhance diversity while preserving semantic meaning. The initial set of candidate prompts can be a diverse sampling of a search space that can include prompt instructions and examples. In one instance, block 310 of the method 300 can be implemented by the prompt optimization system 120 and, more specifically, global initialization component 122 of FIG. 1.

The method 300 proceeds to block 320 with executing multi-phase mutation to produce a revised set of candidate prompts from the initial set of candidate prompts. Multi-phase mutation involves multiple stages or phases of mutation to explore and optimize a search space. Multi-phase mutation combines different mutation operators or techniques sequentially. Each phase can focus on a specific aspect of the solution space and apply a particular mutation operator or technique to the aspect. The output of one phase can serve as the input to the next phase, allowing progressive refinement. In accordance with one embodiment, multi-phase mutation alternates between local and global mutation. By combining different mutation operators in a coordinated manner, multi-phase mutation can enhance an optimization process's exploration and exploitation capabilities, leading to improved performance and better solutions. Multi-phase mutation of block 320 can be implemented by the prompt optimization system 120 of FIG. 1 and, more specifically, local feedback mutation component 124, global evolution mutation component 126, and local semantic mutation component 128.

Next, the method 300 proceeds to block 330 with determining whether a termination condition is satisfied. In one instance, termination conditions can be associated with each phase of multi-phase mutation, such that satisfaction of a termination condition for one phase advances processing to the next phase until all phases are completed and satisfy termination conditions. Alternatively, the termination condition can apply to the last phase of multi-phase mutation, such that satisfying the termination condition corresponds to the completion of multi-phase mutation. The termination condition can be performance-based or pertain to runtime, among other things. If the termination condition is not satisfied (“NO”), then the method 300 can return to block 320 with executing multi-phase mutation. If the termination is satisfied (“YES”), the method 300 can proceed to block 340. Block 330 of method 300 can be implemented by the prompt optimization system 120 of FIG. 1 and components thereof.

The method 300 proceeds at block 340 with selecting a prompt from the revised set of candidate prompts. Each prompt that comprises the revised set of candidate prompts can be evaluated and scored based on performance on an evaluation data set. The prompt with the highest performance score can be selected. The selection process can also consider other factors, such as relevance to a particular task and human feedback. Prompt optimization system 120 or components thereof of FIG. 1 can select the prompt from the revised set of candidate prompts in accordance with one embodiment.

The method 300 continues at block 350 with outputting the selected prompt for use with a machine learning task. The prompt guides a generative artificial intelligence (AI) system, such as a large language model, in generating a desired output. The prompt can include an instruction and zero or more examples to assist in generating a desired response. The prompt optimization system 120 of FIG. 1 can output the selected prompt for use with the large language model 110 in one embodiment.

Method 300 provides technical benefits and provides a technical solution to technical problems associated with suboptimal performing conventional prompts. For instance, the method 300 provides for diverse exploration of a prompt space covering a wide range of possible in-context prompts. Further, improved and efficient search is provided through multi-phase mutation and iterative refinement. Adaptive termination can also control the optimization process and objective evaluation and selection of the most suitable prompt based on fitness scores. Furthermore, prompt generation can be performed automatically without human intervention.

Note that FIG. 3 is just one example of a method, and other methods including fewer, additional, or alternative steps are possible consistent with this disclosure.

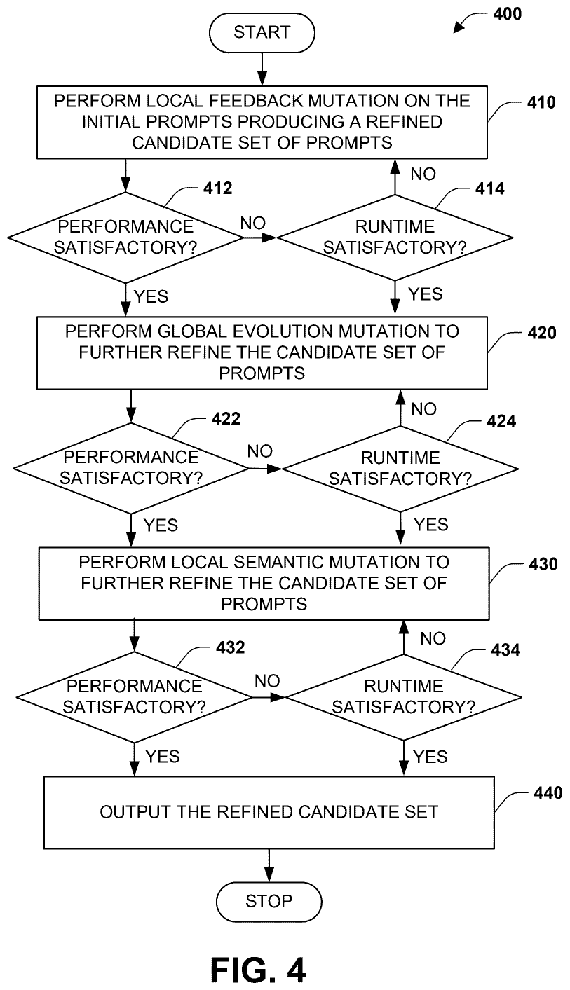

FIG. 4 depicts an example method 400 of prompt optimization with multi-phase mutation. In one aspect, method 300 can be implemented by the prompt optimization system 120 of FIG. 1 and the processing apparatus of FIG. 5. Further, the method can implement multi-phase mutation specified in block 320 in FIG. 3.

The method 400 starts at block 410 with performing local feedback mutation on an initial set or population of candidate prompts, producing a refined set of candidate prompts. Local feedback mutation involves exploiting gradient information to converge each candidate on a local minimum. In accordance with one embodiment, a large language model (LLM) examiner can be employed to identify where a candidate falls short and offers improvement guidance. This guidance is received as a feedback gradient and is further utilized by an LLM improver to generate new candidates by local exploitation. In accordance with certain embodiments, block 410 of method 400 can be performed by the local feedback mutation component 126 of FIG. 1.

For example, consider the following original prompt: “For each word, find its antonym and write it as the output.” An LLM examiner can generate the following feedback: “1. Clarify the definition of ‘antonym’ to ensure the prompt is asking for the opposite meaning of a word. 2.Prove more specific instructions for determining the antonym. 3. Add a list of common antonyms for each word. 4. Provide a context or sentence for each word to help determine the appropriate antonym.” In response, the LLM improver can generate a new prompt that notes, “For each word, find its anonym, which is a word that has the opposite meaning, and write it as the output. The antonym should be a word that is commonly used to express the opposite meaning of the given word, and it should be the same part of speech (e.g., noun, verb, adjective, adverb).” The prompt can also note, “To help you identify the antonym, we have also provided a list of common antonyms for each word. Additionally, a context or sentence for each word is included to help determine the appropriate antonym. Example: Word: Hot, Antonym: Cold. Context: The soup is too hot to eat.” Furthermore, the prompt can note, “Please note that some words may have multiple antonyms depending on the context, so use your best judgment to determine the most appropriate one.”

The method next proceeds to block 412 with determining whether performance is satisfactory. Performance can be deemed satisfactory when performance reaches a performance threshold, when a predetermined level of improvement has been achieved, or when performance metrics have stabilized such that no significant changes are observed or performance improvement is negligible. In accordance with one embodiment, the output generated by a large language model using mutated prompts is compared against a set of metrics or criteria (e.g., accuracy, precision, recall). The comparison can be to the prompts prior to mutation or a previous mutation iteration. If performance is unsatisfactory (“NO”), the method 400 can proceed to block 414. If performance is deemed satisfactory (“YES”), the method can continue at block 420.

The method 400 can continue at block 414 with determining whether runtime is satisfactory. Runtime can be deemed satisfactory after mutation processing time has exceeded a threshold time. Additionally or alternatively, runtime can be deemed satisfactory after a threshold number of mutation iterations has been achieved. If runtime is deemed unsatisfactory (“NO”), the method 400 returns to block 410 to perform further feedback mutation. If the runtime is deemed satisfactory (“YES”), the method continues at block 420.

The method 400 can proceed to block 420 with performing global evolution mutation to further refine the candidate set of prompts returned as a result of local feedback mutation. Global evolution mutation involves selecting parent prompts from the current candidate set of prompts and applying evolution operators such as estimation of distribution mutation or crossover to generate new prompts. ED generates a new prompt by considering a list of parents and their distance metric (e.g., Hamming distance), while CR selects two parents based on their distance and combines the parents to create a new prompt. Employment of global evolution mutation aims to escape local optima and explore a wider range of potential prompts. In accordance with certain embodiments, block 420 can be performed by the global evolution mutation component 126 of FIG. 1.

An LLM can be employed to perform CR, EDA, or both. For example, a prompt can specify: “You are a mutator familiar with the concept of crossover in a genetic algorithm, namely combining the genetic information of two parents to generate new offspring. Given two parent prompts, you will perform a crossover operator to generate an offspring prompt that covers the same semantic meaning as both parents. Given a first parent prompt “prompt 1′ and a second parent prompt ‘prompt 2’ what is the offspring prompt?” Per EDA, an example prompt can be “You are a mutator. Given a series of prompts, your task is to generate another prompt with the same semantic meaning and intentions. ##Existing Prompts ## {existing prompt} What is a newly mutated prompt?”

The method 400 next proceeds to block 422, where a determination is made as to whether performance is satisfactory. Similar to block 412, performance can be deemed satisfactory when performance reaches a performance threshold, when a predetermined level of improvement has been achieved, or when performance metrics have stabilized such that no significant changes are observed, or performance improvement is negligible. The performance thresholds and level of improvement may be the same or different than those in block 412. If the performance is unsatisfactory (“NO”), the method 400 can proceed to block 424. If the performance is satisfactory, the method 400 can continue at block 430.

The method proceeds at block 424, with determining whether runtime is satisfactory. Similar to block 414, runtime can be deemed satisfactory after mutation processing time has exceeded a threshold time or after a threshold number of mutation iterations has been achieved. If runtime is deemed unsatisfactory (“NO”), the method 400 returns to block 420 to perform further evolution mutation. If the runtime is deemed satisfactory (“YES”), the method continues at block 430.

The method continues at block 430 with performing local semantic mutation to refine the candidate set of prompts further. Local semantic mutation focuses on making small changes to a prompt while preserving overall meaning. It involves modifying specific words or phrases in a prompt to generate new prompts that are similar but not identical to the original prompt. This type of mutation is particularly useful when the original prompt is already close to a desired claim due to prior feedback and evolutionary mutation, as it allows for fine-tuning and refinement without drastically altering the overall meaning. Local semantic mutation can involve synonym replacement, negation, antonym insertion, and sentence similarity modification. In accordance with certain embodiments, the local semantic mutation of block 430 can be performed by the local semantic mutation component 128 of FIG. 1.

In one instance, an LLM can be employed to perform semantic mutation. For example, a prompt can specify, “You are a mutator. Given a prompt, your task is to generate another prompt with the same semantic meaning and intentions. #Example current prompt: Your mission is to ascertain the sentiment of the provided text and assign a sentiment label from [‘negative,’ ‘positive’]. Mutated prompt: Determine the given sentence as assigned a label from [‘negative,’ positive’]. Given {current prompt], what is the mutated prompt?”

The method 400 next proceeds to block 432, where a determination is made as to whether performance is satisfactory. Similar to blocks 412 and 422, performance can be deemed satisfactory when performance reaches a performance threshold, when a predetermined level of improvement has been achieved, or when performance metrics have stabilized such that no significant changes are observed or performance improvement is negligible. The performance thresholds and level of improvement may be the same or different than those in blocks 412 and 422. If the performance is unsatisfactory (“NO”), the method 400 can proceed to block 434. If the performance is satisfactory, the method 400 can continue at block 440.

The method proceeds to block 434 with determining whether runtime is satisfactory. Similar to blocks 414 and 424, runtime can be deemed satisfactory after mutation processing time has exceeded a threshold time or after a threshold number of mutation iterations has been achieved. If runtime is deemed unsatisfactory (“NO”), the method 400 returns to block 430 to perform further semantic mutation. If the runtime is deemed satisfactory (“YES”), the method continues at block 440.

The method continues at block 440, with outputting the refined set of candidate prompts. Subsequently, one of the candidate prompts can be selected for use based on evaluating all the candidate prompts in the refined set. In certain embodiments, the prompt optimization system 120 of FIG. 1 can output the refined set of candidate prompts.

Method 400 provides technical benefits and provides a technical solution to technical problems associated with suboptimal performing conventional prompts. For instance, the method 400 provides a multi-phase strategy for automated prompt generation and optimization that utilizes various mutations in a particular order to enhance search efficacy and accelerate convergence. Further, joint optimization is performed on both instructions and examples, which can provide a prompt tailored to the most relevant and effective guidance to a large language model, leading to improved performance of the large language model.

Note that FIG. 4 is just one example of a method, and other methods including fewer, additional, or alternative steps are possible consistent with this disclosure.

### Example Processing System for Prompt Optimization

FIG. 5 depicts an example processing system 500 configured to perform various aspects described herein, including, for example, methods 300 and 400 as described above with respect to FIGS. 3 and 4, respectively.

Processing system 500 is generally an example of an electronic device configured to execute computer-executable instructions, such as those derived from compiled computer code, including without limitation personal computers, tablet computers, servers, smartphones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and one or more memories and/or computer-readable mediums 512. In the depicted example, the aforementioned components are coupled by one or more buses 510, which may generally be configured for data exchange amongst the components. Bus(es) 510 may be representative of multiple buses, while only one is depicted for simplicity.

Processor(s) 502 are generally configured to retrieve and execute instructions stored in one or more memories, including local memory(ies)/computer-readable medium(s) 512, as well as remote memories and data stores. Similarly, processor(s) 502 are configured to store application data residing in local memory(ies)/computer-readable medium(s) 512, as well as remote memories and data stores. More generally, bus(es) 510 is configured to transmit programming instructions and application data among the processor(s) 502, display device(s) 506, network interface(s) 508, and/or memory(ies)/computer-readable medium(s) 512. In certain embodiments, processor(s) 502 are representative of one or more central processing units (CPUs), graphics processing units (GPUs), tensor processing units (TPUs), accelerators, and other general or special-purpose processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any device configured to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, and/or extended reality devices. In various embodiments, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Memory(ies) computer-readable medium(s) 512 may include a volatile memory, such as a random access memory (RAM), or a nonvolatile memory, such as nonvolatile random access memory (NVRAM), or the like. In this example, memory(ies)/computer-readable medium(s) 512 includes global initialization logic 514, local feedback mutation logic 516, global evolution mutation logic 518, local semantic mutation logic 520, evaluation logic 522, and selection logic 524. The global initialization logic 514 can generate an initial set of candidate prompts associated with block 310 of FIG. 3. The local feedback mutation logic 516 can perform local feedback mutation associated with block 410 of FIG. 4. The global evolution mutation logic 518 can perform global evolution mutation associated with block 420 of FIG. 4. Local semantic mutation logic 520 can perform semantic mutation associated with block 430 of FIG. 4. The evaluation logic 522 and the selection logic 524 can evaluate and select a prompt associated with block 340 of FIG. 3.

In certain embodiments, global initialization component 122 of FIG. 1 is configured to perform the global initialization logic 514.

In certain embodiments, local feedback mutation component 124 of FIG. 1 is configured to perform the local feedback mutation logic 516.

In certain embodiments, global evolution mutation component 126 of FIG. 1 is configured to perform the global evolution mutation logic 518.

In certain embodiments, local semantic mutation component 128 of FIG. 1 is configured to perform the local semantic mutation logic 520.

In certain embodiments, the prompt optimization system 120 of FIG. 1 is configured to perform the evaluation logic 522 to evaluate prompt performance.

In certain embodiments, the prompt optimization system 120 of FIG. 1 is configured to perform selection logic 524 to select a prompt for output based on the results of prompt performance evaluation.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of prompt generation, comprises generating an initial set of candidate prompts for a machine-learning task, executing multi-phase mutation starting with the initial set of candidate prompts to produce a revised set of candidate prompts including at least one candidate prompt that comprises an instruction and one or more examples, wherein the multi-phase mutation transitions sequentially through phases with different mutation operations, generating a fitness score for each candidate prompt in the revised set of candidate prompts resulting from the multi-phase mutation, selecting a prompt from the revised set of candidate prompts based on the fitness score for each candidate prompt, and outputting a selected prompt for the machine-learning task.

Clause 2: The method of Clause 1, wherein generating the initial set of candidate prompts comprises executing Lamarckian mutation to predict a prompt given an input and output pair.

Clause 3: The method of Clauses 1-2, wherein generating the initial set of candidate prompts comprises executing semantic mutation to produce new prompts from a human-generated prompt.

Clause 4: The method of Clauses 1-3, wherein a first phase mutation is a local feedback mutation that invokes a large language model to generate a new candidate prompt given a current prompt.

Clause 5: The method of Clauses 1-4, wherein the large language model is employed to scrutinize a candidate prompt, provide improvement guidance as feedback, and generate a new candidate based on the feedback.

Clause 6: The method of Clauses 1-5, wherein a second phase mutation is a global evolution mutation comprising at least one of an estimation of distribution mutation or crossover mutation that generates a new prompt based on parent prompts.

Clause 7: The method of Clauses 1-6, wherein a third phase mutation is a semantic mutation that invokes a large language model to generate a new candidate prompt that shares semantic meaning with a given prompt.

Clause 8: The method of Clauses 1-7, wherein each phase is executed with a minimum number of mutation iterations before proceeding to a subsequent phase.

Clause 9: The method of Clauses 1-8, wherein the multi-phase mutation advances to a subsequent phase after a current phase satisfies a performance gain threshold.

Clause 10: A method of prompt generation, comprising generating an initial set of candidate prompts based on input and output pairs or a human-generated prompt, executing a multi-phase mutation on the initial set of candidate prompts to produce a revised set of candidate prompts, wherein executing the multi-phase mutation, comprises executing a local feedback mutation on the initial set of candidate prompts to produce a first intermediate revised set of candidate prompts, executing a global evolution mutation on the first intermediate revised set of candidate prompts to produce a second intermediate revised set of candidate prompts, and executing a local semantic mutation on the second intermediate revised set of candidate prompts to produce the revised set of candidate prompts, generating a fitness score for each candidate prompt in the revised set of candidate prompts resulting from the multi-phase mutation, selecting a prompt from the revised set of candidate prompts based on the fitness score for each candidate prompt, and outputting a selected prompt for a machine-learning task.

Clause 11: A processing system comprising one or more memories comprising computer-executable instructions; and one or more processors configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 12: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling through an intermediary aspect, such as one or more buses.

The methods disclosed herein comprise one or more actions to achieve the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to, general- and special-purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,” etc.), unless otherwise specifically stated, should be understood to refer to one or more elements (e.g., “one or more processors,” “one or more controllers,” “one or more memories,” etc.).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public, regardless of whether such disclosure is explicitly recited in the claims.

What is claimed is:

1. A method of prompt generation, comprising:
generating an initial set of candidate prompts for a machine-learning task;
executing multi-phase mutation starting with the initial set of candidate prompts to produce a revised set of candidate prompts including at least one candidate prompt that comprises an instruction and one or more examples, wherein the multi-phase mutation transitions sequentially through phases with different mutation operations;
generating a fitness score for each candidate prompt in the revised set of candidate prompts resulting from the multi-phase mutation;
selecting a prompt from the revised set of candidate prompts based on the fitness score for each candidate prompt; and
outputting a selected prompt for the machine-learning task.

2. The method of claim 1, wherein generating the initial set of candidate prompts comprises executing Lamarckian mutation to predict a prompt given an input and output pair.

3. The method of claim 1, wherein generating the initial set of candidate prompts comprises executing semantic mutation to produce new prompts from a human-generated prompt.

4. The method of claim 1, wherein a first phase mutation is a local feedback mutation that invokes a large language model to generate a new candidate prompt given a current prompt.

5. The method of claim 4, wherein the large language model is employed to scrutinize a candidate prompt, provide improvement guidance as feedback, and generate the new candidate prompt based on the feedback.

6. The method of claim 4, wherein a second phase mutation is a global evolution mutation comprising at least one of an estimation of distribution mutation or crossover mutation that generates a new prompt based on parent prompts.

7. The method of claim 5, wherein a third phase mutation is a semantic mutation that invokes a large language model to generate a new candidate prompt that shares semantic meaning with a given prompt.

8. The method of claim 1, wherein each phase is executed with a minimum number of mutation steps before proceeding to a subsequent phase.

9. The method of claim 1, wherein the multi-phase mutation advances to a subsequent phase after a current phase satisfies a performance gain threshold.

10. A processing system, comprising:
one or more processors; and
one or more memories coupled to the one or more processors comprising computer-executable instructions that, when executed by the one or more processors, cause the processing system to:
generate an initial set of candidate prompts for a machine-learning task;
execute multi-phase mutation on the initial set of candidate prompts to produce a revised set of candidate prompts including at least one candidate prompt that comprises an instruction and one or more examples, wherein the multi-phase mutation transitions sequentially through phases with different mutation operations;
generate a fitness score for each candidate prompt in the revised set of candidate prompts resulting from the multi-phase mutation;
select a prompt from the revised set of candidate prompts based on the fitness score for each candidate prompt; and
output a selected prompt for the machine-learning task.

11. The processing system of claim 10, wherein generate the initial set of candidate prompts comprises executing Lamarckian mutation to predict a prompt given an input and output pair.

12. The processing system of claim 10, wherein generating the initial set of candidate prompts comprises executing semantic mutation to produce new prompts from a human-generated prompt.

13. The processing system of claim 10, wherein a first phase mutation is a local feedback mutation that invokes a large language model to generate a new candidate prompt given a current prompt.

14. The processing system of claim 13, wherein the large language model is employed to scrutinize a candidate prompt, provide improvement guidance as feedback, and generate the new candidate prompt based on the feedback.

15. The processing system of claim 13, wherein a second phase mutation is a global evolution mutation comprising at least one of an estimation of distribution mutation or crossover mutation that generates a new prompt based on parent prompts.

16. The processing system of claim 15, wherein a third phase mutation is a semantic mutation that invokes a large language model to generate a new candidate prompt that shares semantic meaning with a given prompt.

17. The processing system of claim 10, wherein each phase is executed with a minimum number of mutation steps before proceeding to a subsequent phase.

18. The processing system of claim 10, wherein the multi-phase mutation advances to a subsequent phase after a current phase satisfies a performance gain threshold.

19. A method of prompt generation, comprising:
generating an initial set of candidate prompts based on input and output pairs or a human-generated prompt;
executing a multi-phase mutation on the initial set of candidate prompts to produce a revised set of candidate prompts, wherein executing the multi-phase mutation, comprises:
executing a local feedback mutation on the initial set of candidate prompts to produce a first intermediate revised set of candidate prompts;
executing a global evolution mutation on the first intermediate revised set of candidate prompts to produce a second intermediate revised set of candidate prompts; and
executing a local semantic mutation on the second intermediate revised set of candidate prompts to produce the revised set of candidate prompts;
generating a fitness score for each candidate prompt in the revised set of candidate prompts resulting from the multi-phase mutation;
selecting a prompt from the revised set of candidate prompts based on the fitness score for each candidate prompt; and
outputting a selected prompt for a machine-learning task.

20. The method of claim 19, wherein the multi-phase mutation transitions iteratively through phases based on satisfying a performance gain computed based on one or more fitness scores before a mutation operation compared to one or more fitness scores after the mutation operation.
